(19) United States
(12) Patent Application Publication
(10) Pub. No.: US 2005/0050051 A1
(43) Pub. Date: Mar. 3, 2005

(54) Generalized mapping model for analysis and control of domain representations and associated data

(75) Inventor: Everett Sherwood, Scottsdale, AZ (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/643,584

(22) Filed: Aug. 19, 2003

(51) Int. Cl. G06F 7/00

(52) U.S. Cl. 707/100

(57) ABSTRACT

A method and apparatus for reconstructing a database structure. A database structure having a domain structure is provided as is data and the database structure then reconstructed into a transformed database structure by generating a plurality of structures. The plurality of structures include structures generated as a function of the domain structure and structures generated as a function of the data.

### FIELD OF THE INVENTION

The present invention relates generally to database management. Specifically, the present invention relates to a system and method for defining and operating a database, and more specifically to a generalized mapping model for analysis and control of domain representations and associated data.

### BACKGROUND OF THE INVENTION

Database management refers generally to the science of organizing and controlling data within a data repository, known as a database.

Two approaches have emerged to dominate the modeling that supports modern database management systems: relational database management systems and object oriented database management systems.

The former, basically, organizes data around the metaphor of tables made up of rows and columns, with each column representing a “field” of data, called an “attribute”, such as name, address, etc. and each row being an independent “record” of data. Within the rubric of the relational database metaphor, a data record is uniquely identified in terms of the domain being modeled by specific values in one or more fields that create a unique “key” to the data. For example, if one table has two columns labeled “first name” and “last name,” they may be used together as a “key” to uniquely identify other values in other columns in that table such as “position” and “company”. The data in a table may be related to other data in other tables by providing the “key” of one table as a column in another table thus creating a “foreign key” which links data records between the two tables. Specifically, for example, if in addition to the table described above, a second table has a column labeled “Social Security Number” and it is used as a “key” to uniquely identify other values in other columns in that table such as “vacation accrual rate” and “employee's pay rate” then the “Social Security Number) may be copied into the first table as a “foreign key” which then links the data records between the two tables.

Object oriented databases, in contrast, adopt a metaphor in which data “objects” have properties in the same sense that relational models have attributes but are 1) distinguished by an identifier, such as a unique number, that is independent of the domain and 2) the objects are contained in classes which may themselves be objects thus allowing subordinate objects to “inherit” properties from higher levels. For example, the object “car” may have the property of “color” and be contained in the class “transportation” with its own properties of “speed” and “weight”.

Various other database management modeling metaphors, such as hierarchical and plex structures have been largely replaced by the relational database metaphor and the object oriented database metaphor.

Problematically, however, all widely adopted and highly sophisticated database management systems presently available follow a model whereby the data is structured according to a database structure or “schema” controlled by a database administrator. Whenever this structure is to be changed such as creating or deleting a relationship between tables or object classes, the database administrator must make an adjustment to the database definition. Such changes impact all the users of the database and may require significant reprogramming of various user applications.

The present invention advantageously addresses the above and other needs.

### SUMMARY OF THE INVENTION

The present invention advantageously addresses the needs above as well as other needs by providing a generalized mapping model for control and analysis of domain representations and associated data.

In one embodiment, the present invention can be characterized as a method for reconstructing a domain structure having the steps of providing a database structure; providing data; and reconstructing the database structure into a transformed database structure comprising generating a plurality of structures, the plurality of structures comprising structures generated as a function of the database structure, and structures generated as a function of the data.

In another embodiment, the present invention can be characterized as a method of generating an object for a linkage identifying an implicit relationship of a data structure having the steps of providing a first object which represents a first portion of the data structure, the first object having a first object identifier uniquely identifying the first object; providing a second object which represents a second portion the data structure, the second object having a second object identifier uniquely identifying the second object, wherein the first portion of the data structure and the second portion of the data structure have the implicit relationship; and generating a third object comprising the first object identifier and the second object identifier, the third object having a third object identifier uniquely identifying the third object, whereby a linkage is created between the first object and the second object.

In another embodiment, the present invention can be characterized as a system for reconstructing a domain structure comprising a database structure; data; and means for reconstructing the database structure into a transformed database structure comprising means for generating a plurality of structures, the plurality of structures comprising structures generated as a function of the database structure, and structures generated as a function of the data.

In another embodiment, the present invention can be characterized as a system of generating an object for a linkage identifying an implicit relationship of a data structure comprising means for providing a first object which represents a first portion of the data structure, the first object having a first object identifier uniquely identifying the first object; means for providing a second object which represents a second portion the data structure, the second object having a second object identifier uniquely identifying the second object, wherein the first portion of the data structure and the second portion of the data structure have the implicit relationship; and means for generating a third object comprising the first object identifier and the second object identifier, the third object having a third object identifier uniquely identifying the third object, whereby a linkage is created between the first object and the second object.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a schematic block diagram of a database coupled through a database management system on a server to a plurality of computing devices;

FIG. 2 is a schematic block diagram illustrating a database such as the database of FIG. 1, coupled to a database management system such as the database management system of FIG. 1, which is coupled to a network;

FIG. 3 is a schematic block diagram, illustrating a network architecture employing the database and database management system of FIG. 1;

FIG. 4 is a block diagram illustrating a relationship between the database, such as the database of FIG. 1, the database management system, such as the database management system of FIG. 1, a transformed database structure and a user application;

FIG. 5 is a schematic diagram of a database structure (and data) as provided by a database management system, such as the database management system of FIG. 1;

FIG. 6 is a simplified block diagram depicting the transformation of multiple databases into canonical structures of the generalized mapping model;

FIG. 7 is a simplified block diagram identifying the seven generalized mapping model representation structures; and

FIG. 8 is an illustration of an array with labeled column headings as can be employed by the database management system of FIG. 1. For most databases, labeled columns are referred to as attributes.

Corresponding reference characters indicate corresponding components throughout the several views of the drawings.

### DETAILED DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

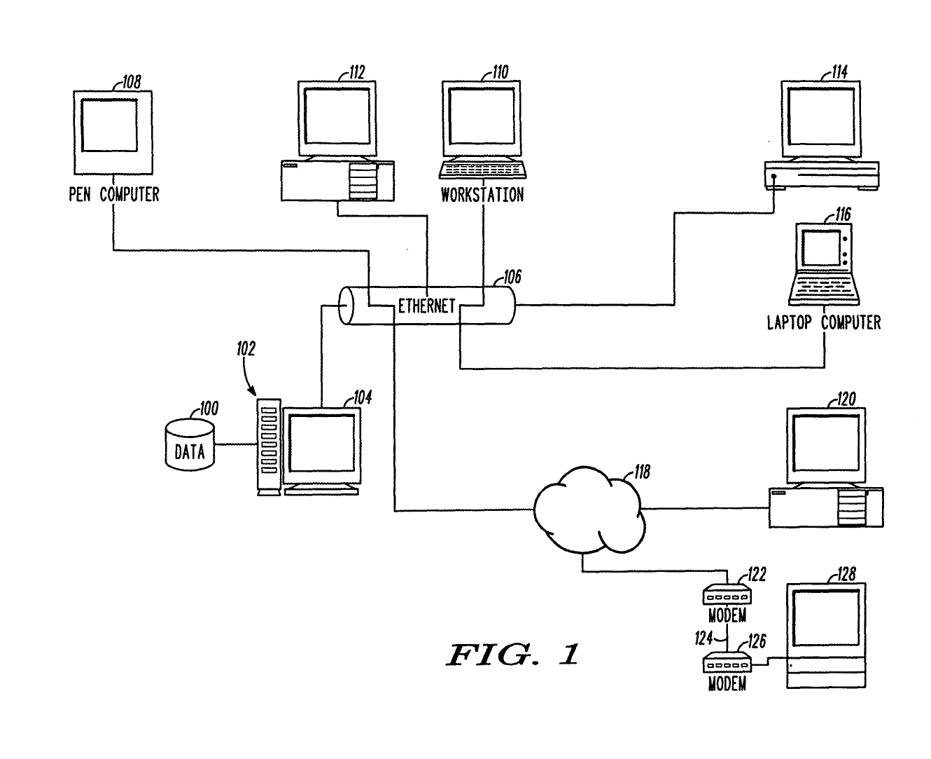

Referring to FIG. 1, shown is a schematic block diagram of a database 100 coupled through a database management system 102 in a database server 104. Also shown is a local area network 106, or intranet to which is coupled a pen-based (or tablet) computer 108, a workstation 110, a first personal computer 112, a second personal computer 114 and a laptop computer 116. The intranet 106 also couples to a wide area network or the Internet 118. By way of example, coupled to the Internet 118 are a third personal computer 120 and a first modem 122. The first modem 122 is coupled through a telecommunications network 124 to a second modem 126, which is in turn coupled to a fourth personal computer 128.

As a result, the pen-based computer 108, the first personal computer 112, the second personal computer 114, the third personal computer 120, the fourth personal computer 128, the laptop computer 116, and the workstation 110 are all communicatively coupled through the intranet 106 (and in the case of the third personal computer 120 and the fourth personal computer 128, through the Internet 118; and in the case of the fourth personal computer 128, through the telecommunications network 124) to the database server 104. Residing on the database server 104 is the database management system 102, and the database management system 102 is communicatively coupled between the intranet 106 and the database 100.

The above elements comprise a network architecture. The above network architecture is shown by way of example only and is not to be construed in a limiting sense. For example, any combination of computing devices, displays, output devices (such as printers) and the like may be coupled, wirelessly or with a physical link, to the intranet 106. Similarly, as is well known in the art, a virtually unlimited number of devices, and an enormous range of types of devices are coupled to the Internet 118. The database server 104 may take any number of forms, and should not be construed as limited only to a single computing device such as a personal computer. For example, the database server 104 may constitute a series of networked personal computers, a minicomputer, mainframe computer, a distributed system of computing devices, or virtually any other suitable database system, as will be appreciated by a skilled artisan upon consideration of the present patent document. Likewise, the database 100 may constitute a single database or a combination of databases that may be physically, logically, or otherwise remote or local relative to one another. The database or databases may be accessible by the database server 102 locally, on the intranet, on the Internet 118 as illustrated, or via any other extranet as may be available and suitable for use in a given application.

In operation, the database management system 102 provides a structure, i.e., a structural metaphor, for how data in the database is “seen” by various constituents' database accessors operating the various computing devices 108, 110, 112, 114, 116, 120, 128 such as illustrated. Accordingly, a user of the first personal computer 112, in accordance with a relational database structural metaphor, accesses data within the database 100 by requesting a particular record within a particular table as defined by the database structure provided by the database management system. The record is broken up into fields. In response to the request, the database management system 102 finds a location, both physically and logically, of the data of the record requested and retrieves the information from the database 100. Again, this operation may involve the database management system 102 retrieving data from a single physical and/or logical database located locally at the database server 104, or may be as complex as retrieving data from multiple databases located at remote and/or local locations, and assembling such data into the “record” requested by the user.

Importantly, no indication of where the data is located either physically or logically, need be “seen” by the user of the database management system 102 (or of a user application), but instead what is provided is data structured in accordance with a database structure (or the domain structure) managed by and provided by the database management system 102 (and a database administrator through the database management system 102).

In order to effect a change in the database structure, the database administrator must generally require exclusive access to the database 100 and adjust the database structure through the database management system 102. Unfortunately, this activity may mean that the database structure expected by the user (and more specifically by the user application used by the user and located on the computing device employed by the user) and the actual database structure may become different resulting in the user application no longer being able to properly manipulate the data. As a further result, catastrophic errors may occur which may or may not be immediately apparent to the user or the database administrator. Accordingly, when changes are made to this database structure, it is necessary for user applications that access the database to be evaluated, and modified if needed, in order to avoid such catastrophe.

This is true even when the changes made to the database structure are of a relatively minor nature, because the user applications operated by the users on their respective computing platforms (including personal and/or on-site devices as well as server-based and/or remote platforms) may be produced by a large number of programmers who may or may not have well documented their work or anticipated any particular changes in the database structure in their programming of the user applications. As a result, database administrators typically resist making changes to the database structure, both because such changes create a substantial risk of catastrophic failure and because effecting such changes across the database management system 102 and all user applications that are accessing the database 100 are time consuming and costly.

In accordance with the present invention, in one embodiment, a mechanism is provided for reconstructing the database structure at the computing device (as opposed to at the database management system). This reconstruction results in a transformed representation of the database structure and data (referred to hereinafter as representation structures and/or transformed database structure), which is highly manipulatable at the computing device by the user or the programmer of the user applications and without the need to alter the database structure. In this way, the user and/or programmer is able to affect changes to the database structure, as seen by the user application, without modifying the database structure at the database management system, and thus without requiring modification of all of the user applications i.e., without altering the database structure seen by other users.

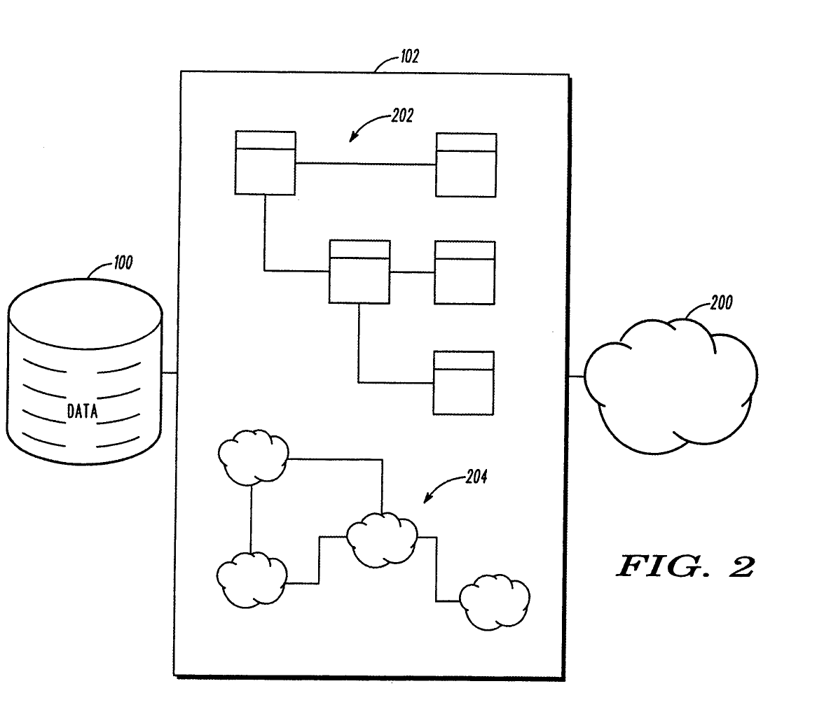

Referring next to FIG. 2, shown is a database 100, coupled to a database management system 102, which is coupled to a network 200. The database 100 may be, for example, the database 100 of FIG. 1, and the database management system 102 may be the database management system 102 of FIG. 1 operating on the database server 104 of FIG. 1. The network 200 may comprise, for example, the intranet 106 of FIG. 1 and the Internet 118 of FIG. 1, as well as the telecommunications network 124 of FIG. 1.

In operation, the database management system 102 provides a database metaphor 202, 204 for an arrangement of data in the database 100. This database metaphor 202, 204 may or may not correspond to the actual physical or logical arrangement of the data within the database 100. As depicted, this database metaphor 202, 204 may be that of a relational database or that of an object oriented database. Numerous other database metaphors are contemplated and are within the scope of the present embodiment.

Thus, when a user accessing the database management system 102 through the network 200 makes an operation on the database such as the retrieval of a record from the database 100, he or she does so by requesting the record from the database management system 102. The database management system 102 then identifies the location of the database 100, physically and logically, it retrieves the data, and presents the data to the user such as by communicating the data through the network 200, in the form expected in accordance with the database metaphor.

Other operations such as deletion or addition of data into and from the database are carried out in a similar manner. For example, should the user wish to add a record to the database 100, a user application located at the computing device of the user is typically used to formulate the record. Once the record is completed by the user application, it is transmitted through, for example, the network, to the database management system 102, which places the record into the database 100. As elaborated upon hereinabove, problems arise when the user wishes to manipulate the database structure of the database 100 as represented through the database metaphor.

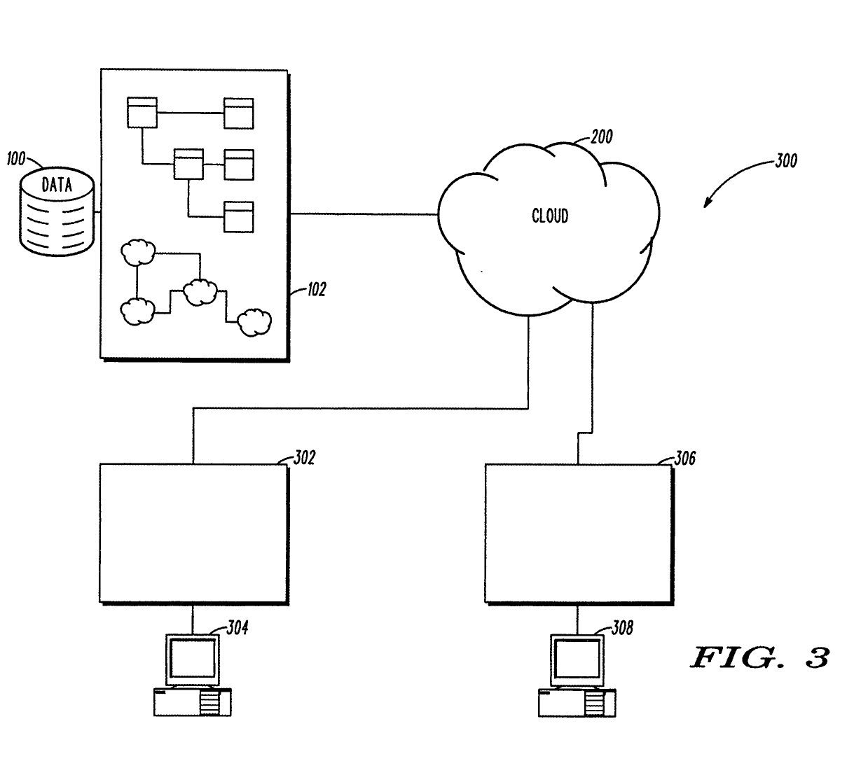

Referring next to FIG. 3, shown is a schematic block diagram, illustrating a network architecture 300 employing teachings of the present embodiment. Shown are the database 100, the database management system 102, the network 200, a first transformed database structure 302, a first computing device 304, a second transformed database structure 306, and a second computing device 308.

As will be elaborated upon hereinbelow, the first computing device 304 (and the second computing device 308) decomposes a database structure, provided by the database management system 102 and the data within the database 100, in order to thereby render separate many (or all) of its corresponding components and thereby facilitate generating the transformed database structure 302. As a result of having decomposed the original database structure and its data, user applications at, for example, the first computing device, are able to manipulate the transformed database structure, i.e., the database structure having been decomposed (or transformed) and/or the data within the database having been decomposed (or transformed).

These transformed structures offer a significant advantage over prior approaches which do not offer the ability at the computing devices 304, 308 to manipulate the database structure and the data, instead requiring that the user make a request of a database administrator who effects changes in database structure through the database management system 102, with the inherent problematic nature of this approach, as described hereinabove.

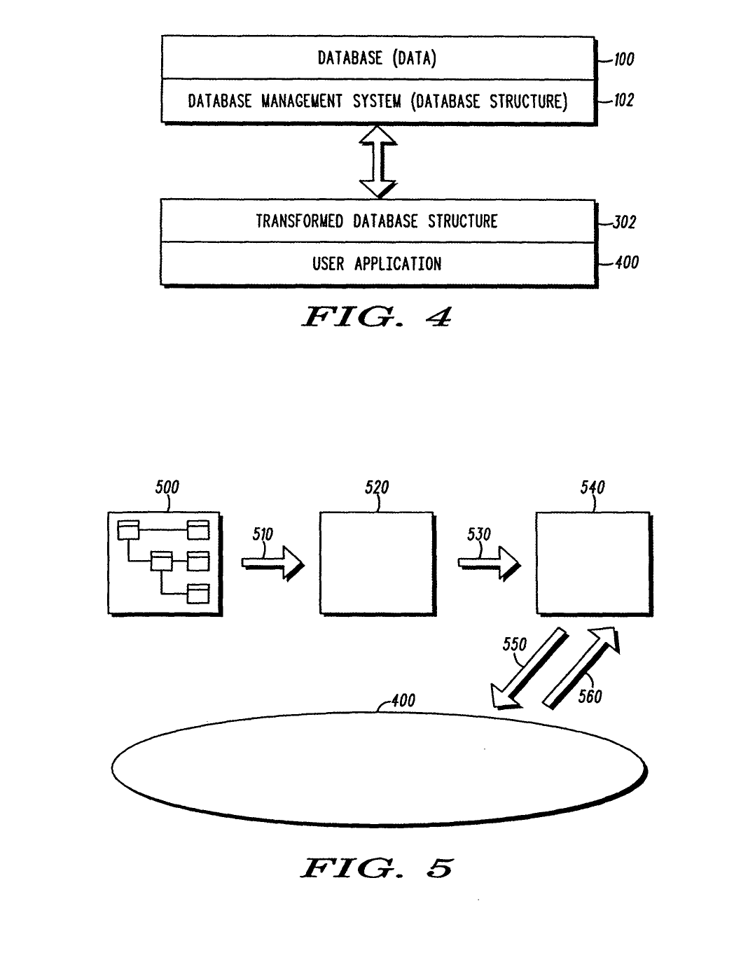

Referring next to FIG. 4, shown is a block diagram illustrating a relationship between the database 100, the database management system 102, the transformed database structure 302 and a user application 400 in accordance with the present embodiment. As can be seen, these elements are depicted here as layers 100, 102, 302, 400 that illustrate the relationship between the user application 400 and the database 100. In this embodiment, the database 100 is directly accessed by the database management system 102, which imposes a database structure on the data. (If desired, these same teachings could be applied in the absence of a database management system as well.) In this way, a database metaphor is applied such that the user application, heretofore, would only see the data in terms of the database metaphor, for example, in rows and columns, tables, or in objects. In accordance with the teachings of the present embodiment, the database structure and the data are retrieved through the database management system 102 and transformed into the transformed database structure 302.

As will be described in further detail hereinbelow, this transformed database structure 302 provides for a tremendously more flexible manipulation of the database structure and data by the user application 400 unconstrained by the original database structure imposed by the database management system 102, and independently of the database management system 102 and database administrator. Thus, when the user application alters the transformed database structure 302, the database structure seen by the database management system 102 is unchanged. In this way, the user application 400 is able to achieve a very powerful level of control over the transformed database structure 302, including the underlying data, without interfering, potentially, with activities of any other user applications that may be simultaneously accessing the database management system 102.

While only a single user application 102 and a single transformed database structure 302 are illustrated in FIG. 4, as was shown in FIG. 3 more than one transformed database structure and more than one computing device (including its user applications) may be coupled to the database management system 102 in this way. In fact, virtually an unlimited number of transformed database structures “seen” by the user application are possible in accordance with the present embodiments. In fact, more than one transformed database structure may be present on a single computing device and each user application may have multiple transformed database structures.

Referring next to FIG. 5, shown is a database structure (and data) 500 (as provided by a database management system, such as the database management system 102 of FIGS. 1 through 4), a decompose step 510, an atomic linkage 520, a domain reconstruction step 530, a transformed database structure 540, an assertion step 550, a custom database structure representation 400, and a user application (or user applications).

The present embodiment, advantageously, provides a system and method for reducing the database structure (and data) 500 to the atomic linkages 520 from which the custom database 560 can be asserted 550 under the control of a user application 400. This system and method will be referred to hereinafter from time to time as a generalized mapping model (GMM). Advantageously, the generalized mapping model allows each user to autonomously restructure the database structure (domain model): to have multiple simultaneous domain models; to compare domain models; to access through the same structures for all applications; and to connect domain information across multiple databases.

The generalized mapping model changes the database structure technologies heretofore known in at least three ways: it makes all implicit relationships explicit; it individually identifies as objects all data values and all linkages; and it places all objects into a set of very simple canonical structures.

The generalized mapping model is intended as a basis for, for example, data warehousing. The generalized mapping model accepts databases as inputs and maps such databases into a standardized form (transformed database structure 540). The user application 400 then is able to manipulate this standard form into the custom database representations 560, while the database structure (and data) 500 remain unchanged. This transformation or mapping may be applied to the analysis of a single database; a set of databases with dissimilar data; or a set of databases with similar data.

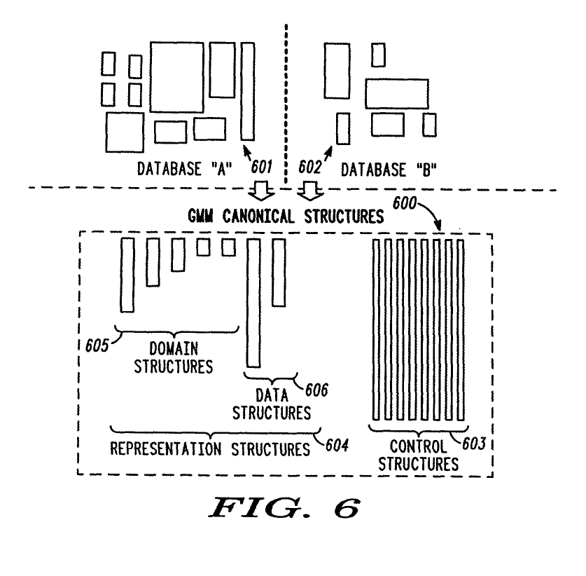

Referring to FIG. 6, a depiction is shown of the transformation of multiple databases into canonical structures of the generalized mapping model 600. Shown are a database 601, a database 602, control structures 603, representation structures 604, domain structures 605, and data structures 606. In accordance with this embodiment, the generalized mapping model accepts the database 601 and the database 602 as inputs, and maps them into the representation structures 604. The representation structures 604 is comprised of two sets of structures: the domain structures 605, which holds the domain of the database 601 and the database 602; and the data structures 606, which holds the data of the database 601 and the database 602. The control structures 603 allow the user to manipulate the representation structures 604 into a customized database representation.

The generalized mapping model's transformation or mapping results from seven transformational steps. These seven steps produce the corresponding representation structures, which make up the transformed database structure. The first five steps capture the database structure. The next two steps capture the data held by the database.

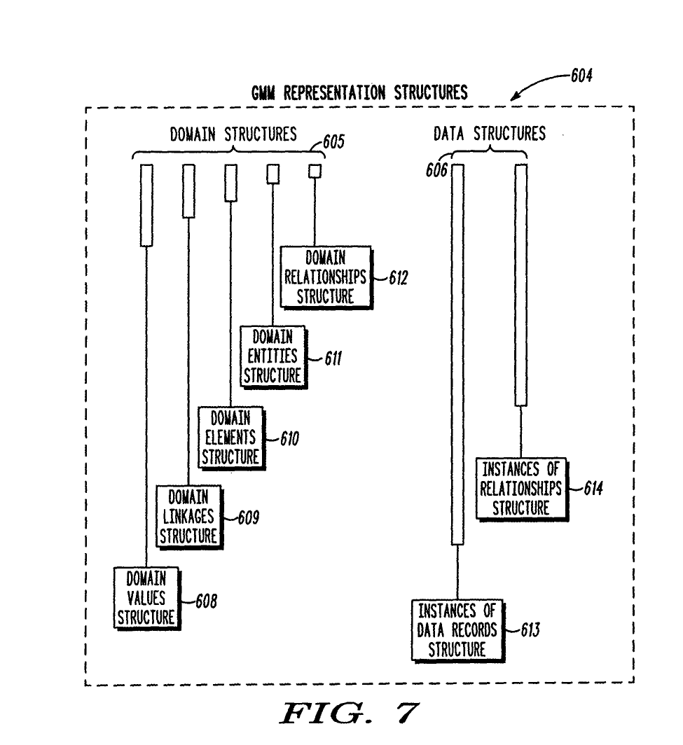

Referring next to FIG. 7, shown is a block diagram identifying the generalized mapping model representation structures 604. The seven structures that make up the representation structures 604 are split into two sets of structures: domain structures 605, and data structures 606. Domain structures 605 comprises five structures: a structure for domain values 608, a structure for domain linkages 609, a structure for domain elements 610, a structure for domain entities 611, and a structure for domain relationships 612. Data structures 606 comprises two structures: a structure for instances of data records 613, and a structure for instances of binary relations 614.

For each structure the following will be provided hereinbelow: The name of the representation structure; the representation structure's purpose; the representation structure's attributes; the transform steps; and an example of the resulting representation structure.

For expository purposes, the discussion hereinbelow first describes the transformation of individual entities and then describes relations between entities. The description begins with the transformation of the domain structure and concludes with the transformation of the data.

Also for expository purposes, the discussion hereinbelow follows a commonly used entity/relational model proposed by Peter Chen, and a resulting database, such as would be housed by the database management system of FIGS. 1 through 4 such as Oracle, DB2, or Sybase, such as are commonly known by those of ordinary skill in the art.

A function providing a unique identifier for each new object is assumed.

For simplicity, the discussion is limited to data types that are nominal values.

Within this document, an object is defined as a set of labeled cells, one of which contains a unique identifier by which the object can be distinguished from every other object. These object identifiers are abbreviated as OID. Note that object identifiers need not be sequential or numeric. Each of the other cells making up an object may hold either data values or another object identifier. If any of the other cells holds an object identifier, the object is referred to as a linkage.

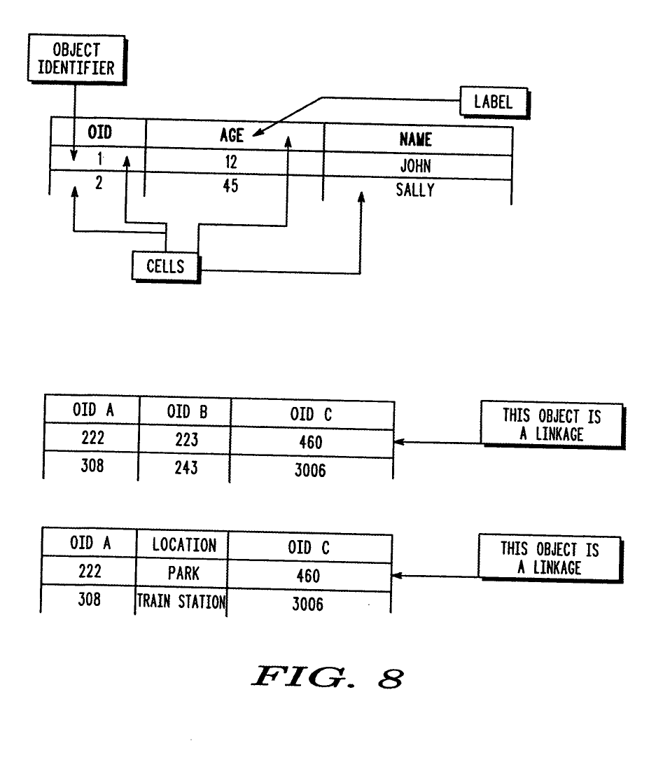

When objects have the same labels in their cells they may be organized into arrays with the labels extracted into column headings as depicted in FIG. 8. For most databases, labels are referred to as attributes.

As a generic approach to modeling a database structure, within this document, a value shall be a possible state of an attribute determined by a process; and a relationship shall be an entity whose attributes always include a linkage (i.e., a relationship must contain a linkage and it may contain attributes).

By way of simple example, the following table describes an entity with two attributes:

TABLE 1
Person

| | |
|---|---|
| Name | Height |

In accordance with one example, each attribute has two possible values. These values are part of the representation of a database structure. In Table 2, below, the values of the attributes are listed. Note that the bottom two rows in Table 2 are not data records, they are independent lists of possible data values.

TABLE 2
Person

| Name | Height |
|---|---|
| Sally | Tall |
| Tomas | Short |

As referred to above, in accordance with the present embodiment, five transformations are used to capture the database structure. The first transformation captures the database nomenclature. The next three transformations are used to capture the construction of individual entities. The fifth transformation captures relationships between entities, and the last two transformations capture the data records and relationships between data records.

The base example in Table 2 is used to determine the first four structures. Later, an expanded example illustrating a relationship and another entity will be introduced as a basis for the transformation of entity relationships.

Note in the examples herein, comment fields are added to assist in clarifying the examples, but are not part of the transformed database structure or database structures.

At the outset, transformation of the database nomenclature is described. The purpose of the domain values structure is to capture all domain nomenclatures. The attributes of a table resulting from this transformation are “object identifier” and “values”. The transformation includes:
1. Creating an object for every structure name:
   i. Entity structure
   ii. Relation structures (including inverse relations and associative structures);
2. Creating an object for every attribute name within every structure; and
3. Creating an object for every value occurring within every attribute.

Table 3 sets forth an example of the database structure represented in Table 2 having had the above-described transformation performed thereon. It is important to emphasize that the generalized mapping model makes each lexical element of the schema a separately identified object by itself. Thus if red, green, and yellow values are values for color, then each will be given a separate object identifier. If a value occurs for more than one attribute, it is only listed once.

TABLE 3

| OID | VALUE | Comment |
|---|---|---|
| 1 | Person | Entity |
| 2 | Name | Attribute |
| 3 | Sally | Value |
| 4 | Tomas | Value |
| 5 | Height | Attribute |
| 6 | Tall | Value |
| 7 | Short | Value |

Next, the domain linkages structure is described. The transformation of implicit domain linkages in the originating schema into explicit objects uses the nomenclature in the domain value structure by referencing the domain term via its object identifier. It uses these object identifier references to create objects for linking domain values to domain attributes and to create objects for linking domain attributes to domain entities (or relations).

Note that the links are directed and this property is designated by the use of “from” and “to” attributes. The direction is assumed to be top down (for example, from “entity to attribute” rather than from “attribute to entity”).

The attributes of the domain linkage are “object identifier”; “object identifier from”; and “object identifier to”.

The steps involved in this transformation are:
1. Creating an object for every linkage of an attribute to a data value; and
2. Creating an object for every linkage of an entity (or relation) to an attribute.

Table 4 illustrates the creation of this structure as a function of the database structure set forth in Table 4. Note that in order to represent the database structure, an attribute is mapped to all of its occurring values.

TABLE 4

| OID (link) | OID (FROM) | OID (TO) | Comment |
|---|---|---|---|
| 8 | 2 | 3 | Name to Sally |
| 9 | 2 | 4 | Name to Tomas |
| 10 | 1 | 2 | Person to name |
| 11 | 5 | 6 | Height to Tall |
| 12 | 5 | 7 | Height to Short |
| 13 | 1 | 5 | Person to Height |

Next, the domain elements structure is described. The purpose of this structure is to build complete data elements from the linkages.

The attributes of this structure are “object identifier”; “object identifier from”; and “object identifier to”.

In this example, in the domain linkages structure described hereinabove, the value “Sally” has been connected to the attribute “name” and the attribute “name” has been connected to the entity “person” but these connections must themselves be linked so as to create the domain element “Sally-name-person”.

The step involved in this transformation is: creating an object for every linkage between the existing linkage of data values to an attribute, and an attribute to an entity (or relation).

Table 5 illustrates this structure resulting from this transformation.

TABLE 5

| OID (link) | OID (FROM) | OID (TO) | Comment |
|---|---|---|---|
| 14 | 10 | 8 | The object “Name to |
| | | | Sally” is linked |
| | | | with the object |
| | | | “Person to Name” in |
| | | | order to build the |
| | | | linkage object |
| | | | “Person to Name to |
| | | | Sally” |
| 15 | 10 | 9 | Person to Name |
| | | | to Tomas |
| 16 | 13 | 11 | Person to Height |
| | | | to Tall |
| 17 | 13 | 12 | Person to Height |
| | | | to Short |

Next we will describe the transform that results in the domain entities structure. In order to refer to an entity as a unit (and thereby provide it with its own object identifier), it is necessary to collect all of the domain elements of an entity together. (These linkages are held and identified in the domain elements structure). Thus, the purpose of this structure is to collect all of the parts of an entity (or relationship) together as a unit. Note that this structure collects domain elements into a set of domain elements without order. Note further that a set of domain elements is also an object itself.

The attributes of this structure are “object identifier”; and “object identifier (element).”

The steps involved in this transformation are:
1. Creating a new object identifier for each entity; and
2. Collecting the linkages that comprise the entity into a unit by repeating the object identifier record for each object identifier element.

In the present example of the people entity, there are four domain elements. These are collected under the common object identifier 100. Table 6 reflects this structure created as a result of this transformation step.

TABLE 6

| OID (entity) | OID (element) | Comment |
|---|---|---|
| 100 | 14 | Person - Name -Sally |
| 100 | 15 | Person - Name -Tomas |
| 100 | 16 | Person - Height -Tall |
| 100 | 17 | Person - Height -Short |

Note that individual relations are entities. From this characterization, it follows that the transformed structures can accommodate relationships which have their own attributes (e.g., “associative entities” in the relational model).

By way of further example, the above example will now be expanded to include relationships between entities, prior to describing the next transforms.

A new entity of “cars” and a relationship of “drive” are added to the domain database structure (see Tables 7 and 8). Note that these tables contain independent lists of possible data values, not data records.

TABLE 7
Drive

| Day | Location |
|---|---|
| Tuesday | Park |
| Friday | Town |

TABLE 8
Cars

| Manufacturer | Color |
|---|---|
| Cadillac | Blue |
| Toyota | Green |
| Mercedes | White |

To accommodate this additional database structure information, the corresponding generalized mapping model structures are augmented (see Table 9, 10, 11 and 12). To distinguish these additions, the previous objects in these tables are indicated with asterisks. Note that there is no required renumbering of the object identifiers of the previous objects.

TABLE 9

| OID | VALUE | COMMENT |
|---|---|---|
| 1 * | Person | Entity |
| 2 * | Name | Attribute |
| 3 * | Sally | Value |
| 4 * | Thomas | Value |
| 5 * | Height | Attribute |
| 6 * | Tall | Value |
| 7 * | Short | Value |
| 20 | Car | Entity |
| 21 | Manufacturer | Attribute |
| 22 | Color | Attribute |
| 23 | Drive | Relation |
| 24 | Cadillac | Value |
| 25 | Toyota | Value |
| 26 | Mercedes | Value |
| 27 | White | Value |
| 28 | Blue | Value |
| 29 | Green | Value |
| 30 | Day | Attribute |
| 31 | Location | Attribute |
| 32 | Tuesday | Value |
| 33 | Friday | Value |
| 34 | Park | Value |
| 35 | Town | Value |

TABLE 10

| OID (link) | OID (FROM) | OID (TO) | Comment |
|---|---|---|---|
| 8 * | 2 | 3 | Name to Sally |
| 9 * | 2 | 4 | Name to Tomas |
| 10 * | 1 | 2 | Person to Name |
| 11 * | 5 | 6 | Height to Tall |
| 12 * | 5 | 7 | Height to Short |
| 13 * | 1 | 5 | Person to Height |
| 36 | 31 | 34 | Location to Park |
| 37 | 31 | 35 | Location to Town |
| 38 | 30 | 32 | Day to Tuesday |
| 39 | 30 | 33 | Day to Friday |
| 40 | 23 | 30 | Drive to Day |
| 41 | 23 | 31 | Drive to Location |
| 42 | 21 | 24 | Manufacturer |
| | | | to Cadillac |
| 43 | 21 | 25 | Manufacturer |
| | | | to Toyota |
| 44 | 21 | 26 | Manufacturer |
| | | | to Mercedes |
| 45 | 20 | 21 | Car to Manufacturer |
| 46 | 20 | 22 | Car to Color |
| 47 | 22 | 27 | Color to White |
| 48 | 22 | 28 | Color to Blue |
| 49 | 22 | 29 | Color to Green |
| 50 | 23 | 2 | Drive to Name |
| 51 | 23 | 21 | Drive to Manufacturer |

TABLE 11

| OID | OID | OID | |
|---|---|---|---|
| (link) | (FROM) | (TO) | Comment |
| 14 * | 10 | 8 | Person to Name to Sally |
| 15 * | 10 | 9 | Person to Name to Tomas |
| 16 * | 13 | 11 | Person to Height to Tall |
| 17 * | 13 | 12 | Person to Height to Short |
| 52 | 40 | 39 | Drive to Day to Friday |
| 53 | 40 | 38 | Drive to Day to Tuesday |
| 54 | 41 | 36 | Drive to Location to Park |
| 55 | 41 | 37 | Drive to Location to Town |
| 56 | 46 | 49 | Car to Color to Green |
| 57 | 46 | 47 | Car to Color to White |
| 58 | 46 | 48 | Car to Color to Blue |
| 59 | 45 | 44 | Car to Manufacturer to Mercedes |
| 60 | 45 | 42 | Car to Manufacturer to Cadillac |
| 61 | 45 | 43 | Car to Manufacturer to Toyota |

TABLE 12

| OID | OID | |
|---|---|---|
| (entity) | (element) | Comment |
| 100 * | 14 | Person - Name - Sally |
| 100 * | 15 | Person - Name - Tomas |
| 100 * | 16 | Person - Height - Tall |
| 100 * | 17 | Person - Height - Short |
| 200 | 52 | Drive - Day - Friday |
| 200 | 53 | Drive - Day - Tuesday |
| 200 | 54 | Drive - Location - Park |
| 200 | 55 | Drive - Location - Town |
| 300 | 56 | Car - Color - Green |
| 300 | 57 | Car - Color - White |
| 300 | 58 | Car - Color - Blue |
| 300 | 59 | Car - Manufacturer - Mercedes |
| 300 | 60 | Car - Manufacturer - Cadillac |
| 300 | 61 | Car - Manufacturer - Toyota |

Next, the domain relationship structure will be described.

The purpose of this structure is to make explicit the linkages that associate one entity with another entity through a relationship. This structure holds “class level” relationships (such as “dogs chase cats”). These “class level” relationships are distinct from “instances of relationships” (where a particular dog chases a particular cat; Butch chases Sylvester). The “instances of relationships” are captured in the data transformation referred to as the instances of relationships structure, described hereinbelow.

The present transformation couples two entities in a named direct relationship. Bi-directional relationships (such as partnership and marriage) are held as two distinct one-way relationships.

The attributes of the relationship's structure are “object identifier”; “object identifier from”; “object identifier to”; and “object identifier relationship”.

Steps involved in this transformation are to create an object for every connection between entities; and to include the relationship as part of the object.

Since, in the present example Object Identifier 100 refers to the people entity and Object Identifier 200 refers to the drive entity and Object Identifier 300 refers to the car entity, the result is depicted in Table 13 as a new object, with an Object Identifier as 400.

TABLE 13

| OID | OID | OID | OID | |
|---|---|---|---|---|
| (link) | (FROM) | (TO) | (RELATIONSHIP) | Comment |
| 400 | 100 | 300 | 200 | People to Drive to Car |

After the domain model has been transformed, the same objects held in the first five structures can be utilized to capture data by the use of two more simple transforms. In the first data transform, individual data records are captured. In the second data transform, instances of relationships are captured.

Before the next two transforms are described, the example described hereinabove is augmented to include data. Therefore, in the tables below, the rows under the domain attributes now represent data records. Thus, in the people entity, the first data record represents an individual named Sally who is short.

TABLE 14
Person

| Name | Height |
|---|---|
| Sally | Short |
| Tomas | Tall |

TABLE 15
Cars

| Manufacturer | Color |
|---|---|
| Mercedes | White |
| Cadillac | Blue |
| Toyota | Green |

TABLE 16

| Name | Day | Location | Manufacturer |
|---|---|---|---|
| Sally | Tuesday | Park | Mercedes |
| Tomas | Tuesday | Town | Cadillac |
| Tomas | Friday | Park | Toyota |

From the expansions of data records in individual entities, the instance relationships between the data are represented; e.g., a short person named Sally drives a white Mercedes in the park on Tuesday.

Note that the capture of these “complete” relationships from a relational database requires expanding the cross product among relational tables. Effectively, this expansion creates denormalized records. In those cases where a single entity record is mapped through a relationship to multiple records in another entity, each composite record is represented individually. Thus there are separate objects for:

A short person named Sally drives a white Mercedes in the park on Tuesday.

A short person named Sally drives a white Mercedes in the park on Friday.

However, their generalized mapping model storage is far more efficient than the cross products of the corresponding relational models since only two object identifiers are needed.

How these statements are constructed in the generalized mapping model is described in the next two transforms.

The next structure is for instances of individual data records.

The purpose of this structure is to collect a set of data elements into a “record.” Note that a record instance is also an object by itself and that this structure collects elements into records without order.

The attributes of this structure are object identifier (record); and object identifier (element). The steps in this transformation are:
1. Creating a new object identifier for each record or row in a table: “Object identifier (record)”; and
2. Grouping the elements that occur in the database into a unit by repeating the object identifier record for each object identifier element.

In the example of the people entity there are two records. (See Table 17.)

TABLE 17

| OID (record) | OID (element) | Comment |
|---|---|---|
| 62 | 14 | Sally, Short |
| 62 | 17 | |
| 63 | 15 | Tomas, Tall |
| 63 | 16 | |
| 64 | 61 | Green Toyota |
| 64 | 56 | |
| 65 | 59 | White Mercedes |
| 65 | 57 | |
| 66 | 60 | Blue Cadillac |
| 66 | 58 | |
| 67 | 52 | Drive on Friday |
| 67 | 54 | in Park |
| 68 | 53 | Drive on Tuesday |
| 68 | 55 | in Town |
| 69 | 53 | Drive on Tuesday |
| 69 | 54 | in Park |

Next, the instances of relationships structure will be described. The purpose of this structure is to provide individual binary relationships between data records. Note that a relationship instance is also an object by itself.

The attributes of this structure are “object identifier”; “object identifier from”; “object identifier to”; and “object identifier relationship”.

Note that the goal is to link a complete record in an originating structure (for example, people) with a complete record in a terminating structure (for example, cars) through a particular relation (for example, drive). This linkage is directed. Undirected relationships, (for example, partnership, marriage, symbiosis) may be accommodated by either ignoring directionality or providing both directions by copying the linkage with the to/from object identifiers reversed. The steps in this transformation are:
1. Creating a new object for each relationship; and
2. Populating the new object with:
   a. The object identifier of the originating object identifier from the instances of individual data records structure;
   b. The object identifier of the terminating object identifier from the instances of individual data records structure; and
   c. The object identifier of the specific relationship from the instances of individual data records structure.

Table 18 illustrates an example of the instances of relationships structure.

TABLE 18

| OID | OID | OID | OID | |
|---|---|---|---|---|
| (link) | (FROM) | (TO) | (Relationship) | Comment |
| 70 | 62 | 65 | 69 | Short Sally drives the |
| | | | | White Mercedes in |
| | | | | Park on Tuesday |
| 71 | 63 | 64 | 67 | Tall Tomas drives the |
| | | | | Green Toyota in |
| | | | | Park on Friday |
| 72 | 63 | 66 | 68 | Tall Tomas drives the |
| | | | | Blue Cadillac in |
| | | | | Town on Tuesday |

The objects in the domain value structures were presented as a means for capturing the domain nomenclature. In the simple example used in the initial exposition of the generalized mapping model, all the data values of these objects were of the data type string. However, the values may be represented in many other formats, called data types. In addition to strings, common data types include integers, reals, bitmaps, images, waveforms, etc. In order to provide for data in these additional formats it is necessary to replace the single data values structure with 1) a pointer structure that then references 2) a set of data value structures, one for each data type. At a minimum, in order to capture the domain nomenclature, a string data structure must exist.

Thus, the data values data type structures will be described.

The purpose of these structures is to hold domain values separately based on their data type. They are used for the representation of both the domain and the data.

The attributes of domain and values data type structure are “object identifier”; and “object identifier value”.

The steps in the transformation to the data values data type structures are:
1. Creating a structure for each data type;
2. Creating within each data type structure an object for every data value of that type; and
3. Creating, as described above, a separate data structure of data type string for the domain nomenclature. Note that this domain structure may be merged with the data structure of the type string.

Note that the value pointers are not objects, their format and values are independent of the object identifiers and they may differ among different data types. The only requirement is that the address is resolvable to a single value. Also note that these referenced structures need not be simple lists.

A string datatype structure is illustrated in Tables 19 and 20.

TABLE 19
Nominal Data Value Structure

| ADDRESS | VALUE |
|---|---|
| 1330303i4 | Person |
| 345224 | Name |
| 355355 | Sally |

TABLE 20
Integer Data Value Structure

| ADDRESS | VALUE |
|---|---|
| AZ12 | 345 |
| IL02 | 2 |
| FL23 | 67 |

Next, the domain values reference structure will be described. The purpose of this structure is to provide a pointer to domain values based on their data type.

The attributes of the domain values reference structure are “object identifier”; “object identifier value pointer”; and “data type structure”.

The steps involved in transforming to the domain values referenced structure are:
1. Create an object for every data value held in any of the domain and data values data type structures:
   a. identify the structure by name, and
   b. identify the location in the structure by an address or pointer value.

Table 21 illustrates the domain value reference structure.

TABLE 21

| OID | VALUE POINTER | DATATYPE STRUCTURE |
|---|---|---|
| 1 | 1330303i4 | String |
| 2 | 345224 | String |
| 3 | 355355 | String |
| 80 | AZ12 | Integer |
| 81 | IL02 | Integer |
| 82 | FL23 | Intege |

At this point all of the information in the database structure as well as the corresponding data has been allocated to the generalized mapping model standard structures, and the transformed database structure is a complete representation of the original domain structure and its data.

The following describes an exemplary means of reconfiguring the domain structure and the data using objects in the generalized mapping model's transformed database structure.

Bitmaps have been used extensively in computer applications such as operating systems and image representations. Although these structures are not part of the above-described transform, per se, they are especially useful as auxiliary structures and are included in the present document to show how the transform enables the adaptability of the domain model.

Next, the object control structures will be described.

The purpose of the object control structures is to identify which parts of the database match a condition. Note that there is only one structure for each condition. A condition is a declaration: “These objects are asserted for financial analysis.” There is one object control structure for each condition.

Also note that the number of bits in an object control structure is the same as the number of objects. (An alternative approach is to create a separate structure per transformed structure per condition.) The only attribute of the object control structures is status.

The steps in the transform to the object control structures are:
1. Define the condition (for example, “if deleted”) and create a corresponding bitmap; and
2. Set the bits corresponding to the objects that are asserted for the particular condition.

An example of an object control structure is shown in Table 22.

TABLE 22
Status:
1
1
1
0
1
0
1
0
.
.
.
1

In general the use of object control structures is to identify which objects are asserted for a particular purpose.

As a simple example, to identify which objects are deleted, a bit is first asserted for every object and then a bit is retracted corresponding to each deleted object. The object may be a data record, entity, domain value, domain element, or any other object. Note that with the use of a control map for deletion, no object is actually removed; only a bit is retracted in the map to indicate deletion.

As an example, following the data given previously, if we want “Tomas to drive on Friday” and “not drive on Tuesday,” a control map can be created for the days that people drive and the conditions above can be captured by asserting the bit for object 71 and retracting the bit for object 72.

As with any database action, there may be logical consequences to a deletion such as a “cascade effect” where by the retraction of one object may require the retraction of other, perhaps many, objects, each of which in turn may require the retraction of other objects (and so on). The dependency of objects may be assessed by another data commonly used in data modeling to show one-to-many “part/whole” relationships such as occur in “bill of material” models and depicted in Table 23.

TABLE 23
Object Dependency

| OID | OID (DEPENDENT) |
|---|---|
| 232 | 3556 |
| 232 | 340 |
| 3098 | 7688 |
| 3098 | 9964 |
| 340 | 567 |
| 340 | 4334 |
| 340 | 345 |
| 567 | 2234 |

For control of the objects in the generalized mapping model, there is one bit for every object ever generated. Note that each object control structure is itself an object and is identified by an object identifier. At a minimum there is a control bit map for all “created” objects.

The control maps can be combined to create assertions of complex conditions (e.g., a Boolean operator such as “inclusive or” may be used to combine two maps). A set of these maps can increase the computational speed by holding different partial results in each map and then, by the use of logical operators (AND, NOT, IOR, and XOR) provide results for complex assertions.

Note that a separate control map may be created for any desired condition. The condition is, effectively, the map. Thus, asserting/retracting bits can customize a configuration of the domain structure, which allows “sub databases” to be defined from a composite database, thereby permitting a constructive definition of context (i.e., what linkages (represented by objects) are activated/deactivated in a sub database for a given set of conditions).

Since a bitmap is a type of data format, after each control map is created, it becomes an object in the domain value bitmap structure.

While the invention herein disclosed has been described by means of specific embodiments and applications thereof, numerous modifications and variations could be made thereto by those skilled in the art without departing from the scope of the invention set forth in the claims.

1. A method for reconstructing a database structure comprising:
providing a database structure having a domain structure;
providing data; and
reconstructing the database structure into a transformed database structure comprising generating a plurality of structures, the plurality of structures comprising structures generated as a function of the domain structure, and structures generated as a function of the data.

2. The method of claim 1 wherein said domain structure is selected from the group consisting of relational metaphors, object-based metaphors, network metaphors, hierarchical metaphors, and combination thereof.

3. The method of claim 1 wherein said reconstructing comprises:
generating a structure for domain values;
generating a structure for domain linkages;
generating a structure for domain elements;
generating a structure for domain entities; and
generating a structure for domain relationships.

4. The method of claim 1 wherein said reconstructing further comprises:
generating a structure for instances of data records; and
generating a structure for instances of binary relations.

5. The method of claim 4 wherein said reconstructing further comprises:
generating individual structures for data types.

6. The method of claim 4 wherein said reconstructing further comprises:
generating a structure for domain values reference.

7. The method of claim 1 further comprising:
generating an object control structure.

8. The method of claim 7 further comprising:
generating a second object control structure.

9. The method of claim 8 further comprising:
performing at least one of a logical operation and set operation on said object control structure and said second object control structure.

10. The method of claim 7 further comprising:
manipulating said database structure by modifying said object control structure.

11. The method of claim 10 wherein said manipulating does not change said database structure.

12. The method of claim 10 wherein said manipulating does not require authorization from a database management system.

13. The method of claim 7 further comprising:
manipulating said data by modifying said object control structure.

14. The method of claim 13 wherein said manipulating does not change said data.

15. A method of using a bitmap as a control structure to customize a configuration of a domain structure comprising:
providing an object control structure; and
applying the bitmap to the object control structure, wherein such applying results in a customized configuration of the domain structure.

16. The method of claim 15 wherein said customized configuration of said domain structure defines a sub database of a composite database.

17. The method of claim 15 further comprising:
defining a condition for said object control structure; and
asserting or retracting a bit of said bitmap corresponding to the condition.

18. The method of claim 15 further comprising:
combining a plurality of bitmaps; and
generating said bitmap in response to the combining of the plurality of bitmaps.

19. The method of claim 18 wherein said combining further comprises:
performing at least one of a logical operation and set operation on said plurality of bitmaps.

20. A method of generating an object for a linkage identifying an implicit relationship of a data structure comprising:
providing a first object which represents a first portion of the data structure, the first object having a first object identifier uniquely identifying the first object;
providing a second object which represents a second portion the data structure, the second object having a second object identifier uniquely identifying the second object, wherein the first portion of the data structure and the second portion of the data structure have the implicit relationship; and
generating a third object comprising the first object identifier and the second object identifier, the third object having a third object identifier uniquely identifying the third object, whereby a linkage is created between the first object and the second object.

21. The method of claim 20 further comprising:
providing a fourth object, the fourth object having a fourth object identifier uniquely identifying the fourth object, wherein the fourth object represents a third portion of said data structure which also shares said implicit relationship with said first portion of said data structure and said second portion of said data structure;
wherein said generating of said third object further comprises the fourth object identifier, whereby said linkage is created between said first object, said second object, and the fourth object.

22. The method of claim 20 wherein said linkage captures a portion of a domain structure.

23. The method of claim 20 wherein said linkage captures data held by a database.

24. The method of claim 20 wherein said third object is used to create one selected from the group consisting of a domain linkage structure, a domain element structure, a domain relationship structure, and an instances of relationship structure.

25. A system for reconstructing a domain structure comprising:
a database structure;
data; and
means for reconstructing the database structure into a transformed database structure comprising means for generating a plurality of structures, the plurality of structures comprising structures generated as a function of the database structure, and structures generated as a function of the data.

26. The system of claim 25 wherein said domain structure is selected from the group consisting of relational metaphors, object-based metaphors, network metaphors, hierarchical metaphors, and combination thereof.

27. The system of claim 25 wherein said means for reconstructing comprises:
means for generating a structure for domain values;
means for generating a structure for domain linkages;
means for generating a structure for domain elements;
means for generating a structure for domain entities; and
means for generating a structure for domain relationships.

28. The system of claim 25 wherein said reconstructing further comprises:
means for generating a structure for instances of data records; and
means for generating a structure for instances of binary relations.

29. The system of claim 25 further comprising:
means for generating an object control structure.

30. The system of claim 25 further comprising:
means for generating a second object control structure.

31. The system of claim 30 further comprising:
means for performing at least one of a logical operation and set operation on said object control structure and said second object control structure.

32. The system of claim 29 further comprising:
means for manipulating said database structure by modifying said object control structure.

33. A system of using a bitmap as a control structure to customize a configuration of a domain structure comprising:
means for providing an object control structure; and
means for applying the bitmap to the object control structure, wherein such applying results in a customized configuration of the domain structure.

34. The system of claim 33 wherein said customized configuration of said domain structure defines a sub database of a composite database.

35. The system of claim 33 further comprising:
means for defining a condition for said object control structure; and
means for asserting or retracting a bit of said bitmap corresponding to the condition.

36. The system of claim 33 further comprising:
means for combining a plurality of bitmaps; and
means for generating said bitmap in response to the combining of the plurality of bitmaps.

37. The system of claim 36 wherein said means for combining further comprises:
means for performing at least one of a logical operation and set operation on said plurality of bitmaps.

38. A system of generating an object for a linkage identifying an implicit relationship of a data structure comprising:
means for providing a first object which represents a first portion of the data structure, the first object having a first object identifier uniquely identifying the first object;
means for providing a second object which represents a second portion the data structure, the second object having a second object identifier uniquely identifying the second object, wherein the first portion of the data structure and the second portion of the data structure have the implicit relationship; and
means for generating a third object comprising the first object identifier and the second object identifier, the third object having a third object identifier uniquely identifying the third object, whereby a linkage is created between the first object and the second object.

39. The system of claim 38 further comprising:
means for providing a fourth object, the fourth object having a fourth object identifier uniquely identifying the fourth object, wherein the fourth object represents a third portion of said data structure which also shares said implicit relationship with said first portion of said data structure and said second portion of said data structure;
wherein said means for generating of said third object further comprises the fourth object identifier, whereby said linkage is created between said first object, said second object, and the fourth object.

40. The system of claim 38 wherein said linkage captures a portion of a domain structure.

41. The system of claim 38 wherein said linkage captures data held by a database.

42. The system of claim 38 wherein said third object is used to create one selected from the group consisting of a domain linkage structure, a domain element structure, a domain relationship structure, and an instances of relationship structure.
